(19) United States
(12) Patent Application Publication
(10) Pub. No.: US 2022/0095783 A1
(43) Pub. Date: Mar. 31, 2022

(54) Injury Reduction Mechanism

(71) Applicant: Michael Halaska, Clearwater, FL (US)

(72) Inventor: Michael Halaska, Clearwater, FL (US)

(21) Appl. No.: 17/542,450

(22) Filed: Dec. 5, 2021

Related U.S. Application Data
(63) Continuation of application No. 17/152,734, filed on Jan. 19, 2021.
(60) Provisional application No. 63/101,167, filed on Apr. 20, 2020.

(51) Int. Cl. A46B 17/02

(52) U.S. Cl. CPC A46B 17/02

(57) ABSTRACT

A mechanism for assisting painters and other persons who hold manual tools for long periods of time is disclosed. In the painter embodiment, the mechanism assist painters in gripping a paintbrush, including retaining control of the brush even during non-gripping intervals. The mechanism reduces pain and cramping partly be allowing for frequent release of the grip, thereby lessening pain and cramping. The mechanism also prevents or delays onset of carpal-tunnel by not forcing them to grip their paint laden paintbrush 100% of the time. This reduces a problem arising from a constant application of thumb, forefinger, and auxiliary fingers in a permanent clamping motion.

### BACKGROUND OF THE INVENTION

A commonly used heavily-laden paintbrush has a significant amount of weight which is continuously manipulated via a constantly-clamped forefinger-auxiliary-fingers-to-thumb grasp. Unfortunately for painters, this occurs in a stress-inducing manner for the joints, ligaments, nerve tissue, and muscles of the painter's hand. This unfortunate fact occurs because the process of painting involves a multitude of movements encompassing a large range of motion occurring over many directions. There is simply no other way to achieve the goal of full surface coverage of a typical room, wall, and/or ceiling that is the usual subject of a professional painting task for the painters.

For almost all painters, of any age and any size of hand, it can be difficult to continuously grip and maintain control over and manipulate a heavy object through this range-of-motion. The continuous forceful grip maintained upon the paintbrush over years of doing such leads inevitably to carpal-tunnel syndrome or other repetitive-range-of-motion issues. Carpal-tunnel syndrome is common amongst long-term painters and is directly caused by the necessity to constantly clamp forefinger-auxiliary-fingers-to-thumb of a relatively heavy paint-laden paintbrush e.g. 8 hours per day potentially over a period of many years. Consequently, a mechanism for reducing these problems is desired.

### DETAILED DESCRIPTION OF THE DRAWINGS

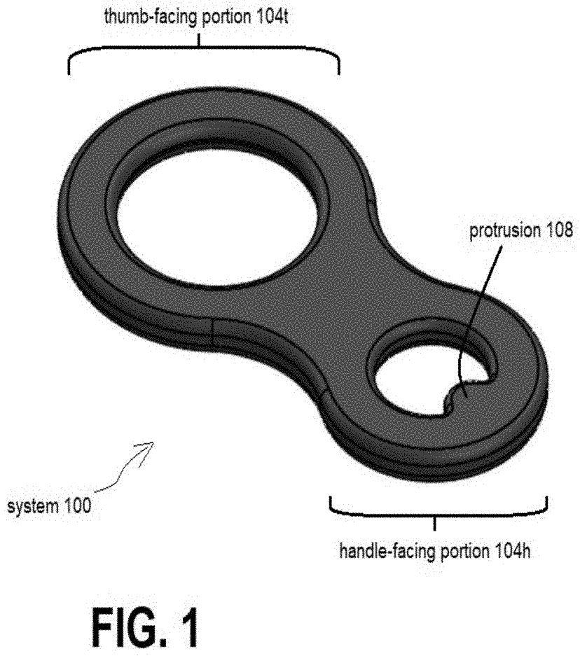

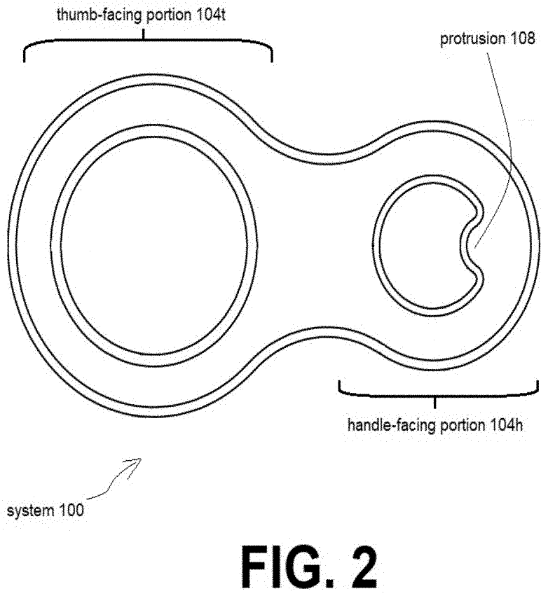

FIGS. 1 and 2 show an embodiment by itself, not attached to a paintbrush;

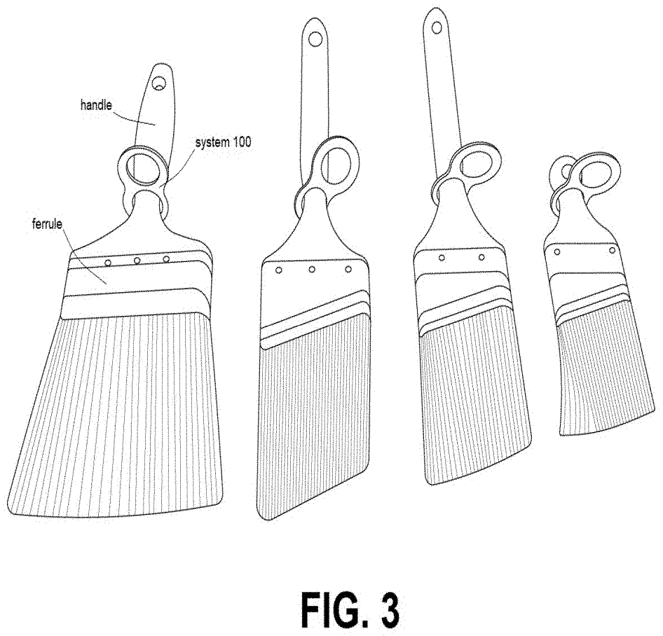

FIG. 3 show various embodiments attached to varying sizes of paintbrushes;

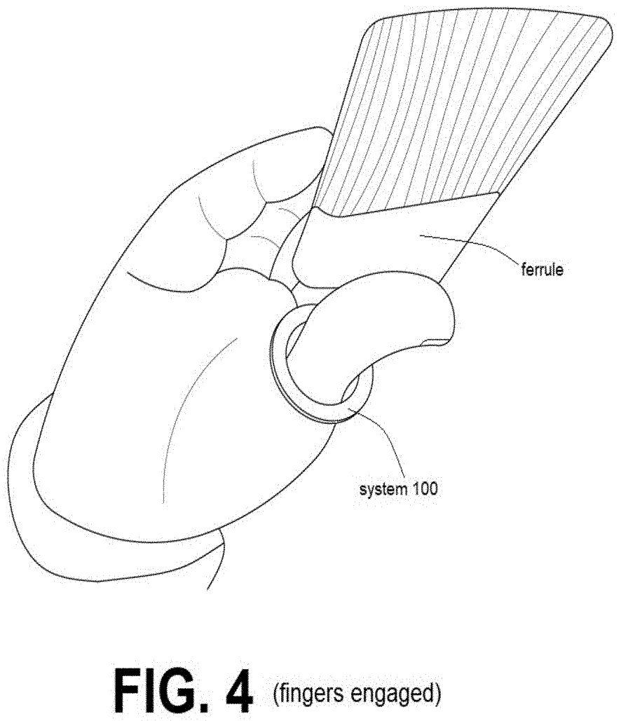

FIG. 4 shows an embodiment in-use, where a user's fingers are engaged with a paintbrush;

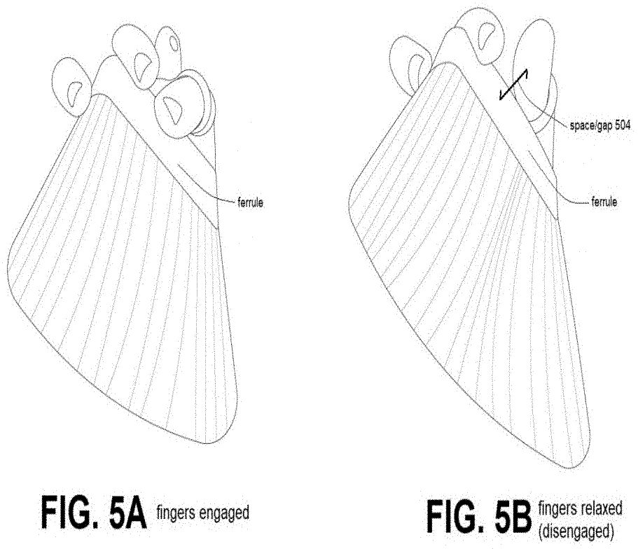

FIG. 5A and FIG. 5B show an embodiment in-use, where in FIG. 5A the fingers are engaged with the paintbrush, and in FIG. 5B the fingers are relaxed (disengaged) with the paintbrush;

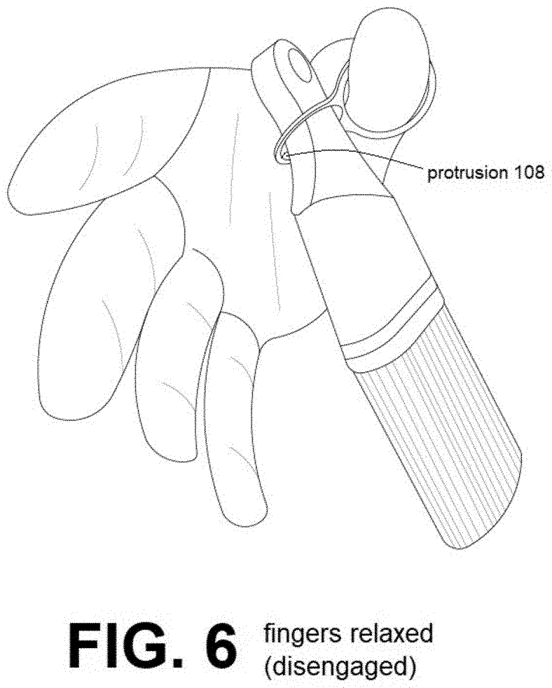

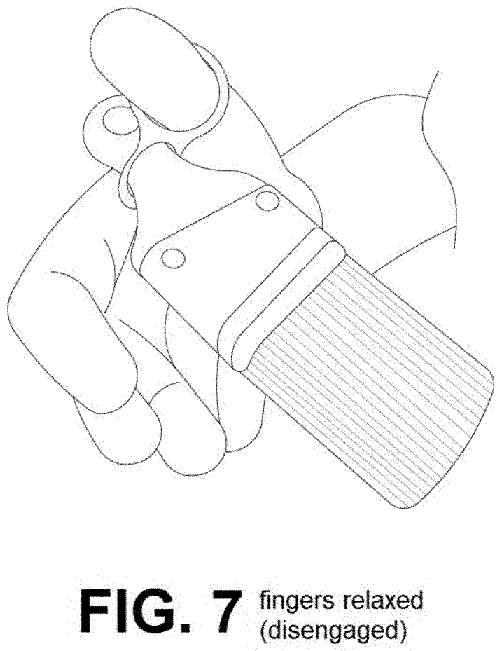

FIG. 6 and FIG. 7 show an embodiment in-use, where the fingers are relaxed (completely disengaged) with the paintbrush;

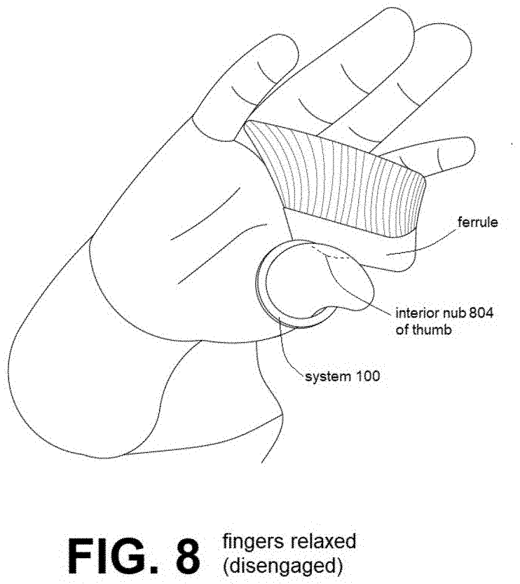

FIG. 8 show an embodiment in-use, where the fingers are largely disengaged with the paintbrush, but a thumb is slightly in contact with the paintbrush;

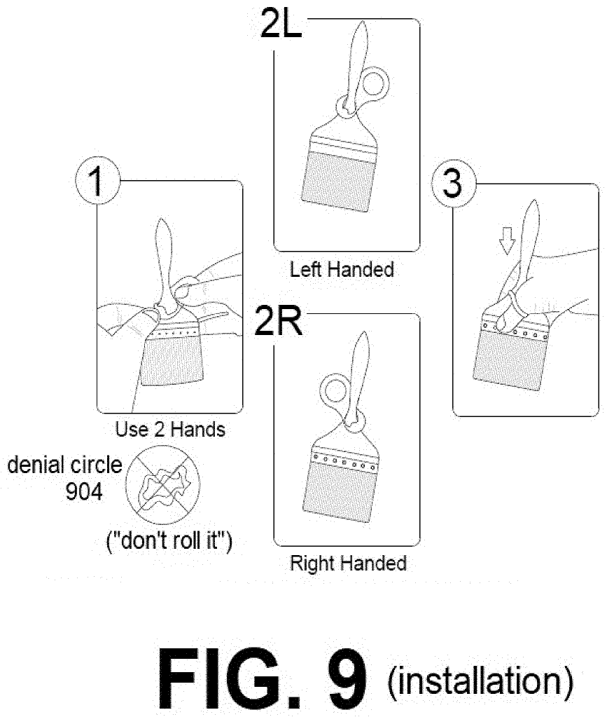

FIG. 9 shows some detail about installation of the embodiments;

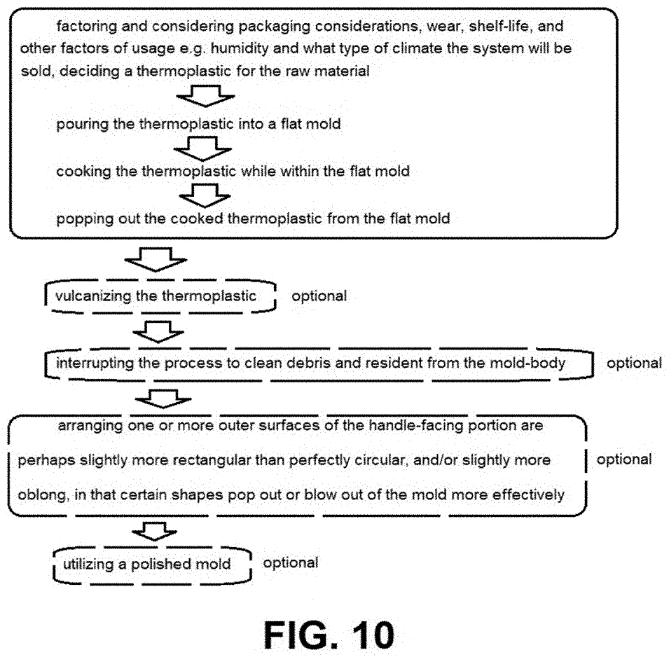

FIG. 10 shows a flowchart of an example manufacturing process;

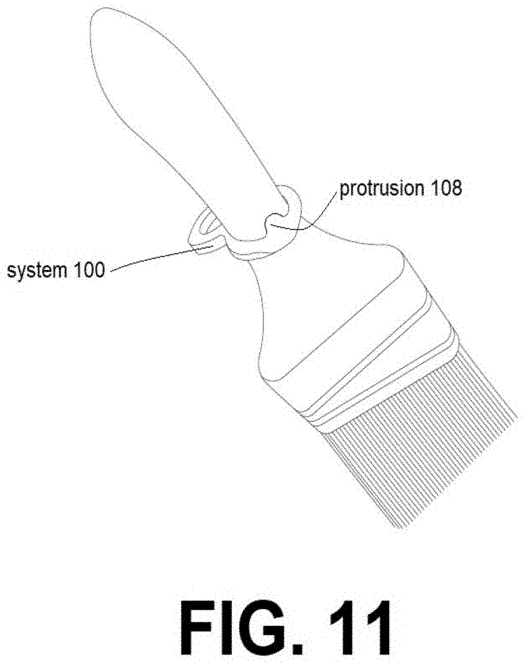

FIG. 11 shows a view of a protrusion within the embodiments; and

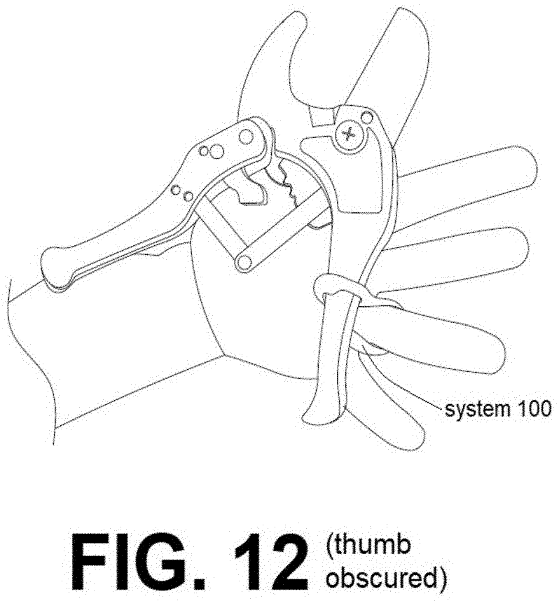

FIG. 12 shows the embodiment installed on a hand tool being held by a user, where that user's thumb is obscured.

### DETAILED DESCRIPTION OF THE PREFERRED EMBODIMENTS

Various embodiments of a system, method and device for assisting professional painters are disclosed. The embodiments herein either prevent, delay the onset of, and/or alleviate carpal-tunnel syndrome.

A typical painter may have a dominant working hand which holds the paintbrush >80% of the time. That is, the index finger of their dominant hand can be thought of as a type of trigger finger. In such a case, this painter sometime requires surgeries due to the problems in their trigger finger, or other fingers, associated with holding their paintbrush for long periods in a day, over many years.

The embodiments herein address this problem by aiding older painters in gripping their paint laden paintbrush (because it allows for frequent release of that grip) thereby lessening their continual pain and cramping. The embodiments herein also aid younger painters prevent or delay onset of carpal-tunnel by not forcing them to grip their paint laden paintbrush 100% of the time. In both cases, this reduces a problem arising the constant application of thumb, forefinger, and auxiliary fingers in a clamping motion.

The specific effect of the embodiments disclosed herein may vary according to whether being used by younger painters that may have lesser amounts of affliction in their fingers/hands, as opposed to older painters that already have some type of repetitive-range-of-motion malady. Either way, the embodiments herein either provide prevention of, remediation of, and/or lessening of the painfulness of carpal tunnel syndrome, or other motion-related affliction.

Within this disclosure, a typical paintbrush will be assumed to have at least a handle, and a ferrule, as shown at least within FIG. 3. To that end, FIGS. 1 and 2 show an embodiment of the system 100 by itself, not attached to a paintbrush. From FIGS. 1 and 2 it is apparent that the system 100 comprises a dual ring structure with a handle-facing portion (ring) 104h and a thumb-facing portion (ring) 104ₜ. The word “ring” is used here at the beginning of this disclosure because FIGS. 1 and 2 show the system 100 in the format of a dual-ring structure. However, a better word than “ring” might be “portion”, in that some embodiments of the system 100 may be other than ring-shaped. Further, the specific dimensions shown in FIGS. 1 and 2, and other Figures herein, are merely for reference purposes and should not be considered limiting. The system 100 is made in a variety of sizes.

The handle-facing portion 104h, and finger-facing portion 104ₜ may be the same size, or may be different-sized. Further, in an embodiment, the handle-facing portion 104h has a protrusion 108, which will be described in more detail with respect to FIGS. 9 and 11 at least.

However, FIGS. 1 and 2 are for illustration only, such that the specific size-relationship of the dual rings is merely a suggestion, an example, and that other size-relationships other than what is shown in FIGS. 1-2 or indeed any of the Figures herein, are possible. Further, other specific thicknesses are possible besides what is shown in FIGS. 1-2. For example, the system 100 can be applied to a portrait-painter, where those artistic brush-handles have a narrower width than brushes for wall-painting and house-painting. In such a case, the handle-facing portion 104h would likely also be narrower than what is shown in FIGS. 1-2.

Further, the system 100 could be employed by someone who is responsible for repeatedly entering information into a tablet, especially in unusual weather climates and potential rain, where mere fingers may not be suitable and instead a computer-stylus is used. Such a person may have long periods of data-entry where they cannot let go of the stylus. It's true that the stylus is often tethered to the tablet, but the inconvenience of letting go of the stylus and then having to grab it again as it dangles, remains. The system 100 would solve this problem.

It is also contemplated that the system 100 could be used by persons who have only partial-use or limited use of their hands and fingers, e.g. for gripping silverware and eating utensils. Within this disclosure, most of the illustrations will use paintbrushes as examples, for clarity. However, the embodiments herein should not be considered as limited exclusively thereto.

FIG. 3 show various embodiments attached to varying sizes of paintbrushes. From FIG. 3 it is apparent that the system 100 is paintbrush-agnostic, and works with any brand or size of paintbrush. The system 100 works with all paintbrushes, and maintains the same hand-feel on the ferrule throughout all common sizes of paintbrushes.

FIG. 4 shows an embodiment in-use, where a user's fingers are engaged with a paintbrush. FIG. 4 is included in order to show a conventional use of a paintbrush, and how and where finger-strain, knuckle-strain, joint-strain, ligament-strain, might be generated. It is to be understood that the system 100 alleviates pain and stress, but the user still must occasionally grip the paintbrush in the conventional way, in order to paint (verb) effectively.

FIGS. 5A and 5B show an embodiment in-use, where in FIG. 5A the fingers are engaged with the paintbrush, and in FIG. 5B the fingers are relaxed (disengaged) with the paintbrush, and yet still retaining grip, control, and accessibility of the paintbrush. The two are shown side-by-side in order to show the fine distinctions in hand-position introduced by the system 100.

In FIGS. 5A-5B, the focus should be mainly on the thumb. In FIG. 5A the thumb is tightened, clamped to the ferrule, and thus in-place for holding the paintbrush during a painting motion. However, FIG. 5B shows the same user, the same hand, the same brush, with the thumb somewhat lifted off the surface of the ferrule, as symbolized by the space or gap 504. Yet, the paintbrush is still under full control of the user, including angle and position. Yet with the thumb non-clamped, or (literally) “relaxed”, a significant reduction of strain on the user's fingers and joints occurs. The muscles controlling the thumb-position need not be engaged and receiving electrical energy for controlling the musculature. The same is true for the fingers, but FIGS. 5A-5B are focused mainly on the thumbs. It is difficult to illustrate all the different strain-relief aspects of the system 100 in only one single drawing. Multiple drawings are needed, as shown below.

FIGS. 6 and 7 show an embodiment in-use, where the fingers are relaxed (completely disengaged) from the ferrule, and thus not in contact with the paintbrush. However, even with the fingers disengaged, the system 100 enables a user to still control and easily and quickly manipulate and move the paintbrush, if necessary. This movement and control is done more by the palm-side of the hand, the overall hand, rather than any specific fingers Specifically, the interior surfaces of the hand, along with the ring 104h achieve the gripping. Thus, the “gripping” (control) of the paintbrush is achieved not by the hand itself, but instead by the system 100. This circumstance could occur, for example, when a user wishes to keep the paintbrush out of the way of some object or manual task.

It should be understood that some gripping of the paintbrush is necessary, in order to not drop it. But with the system 100, that gripping does not always need to be performed by the human hand doing the painting.

The system 100 is low-cost and replaceable. While the system 100 is manufactured to be durable and wear-resistant, even in the event one wears out, it can be easily and quickly replaced with another, unlike a human hand. That is, when a human hand wears out, it is not easily replaced.

FIG. 8 shows an embodiment in-use, where the fingers are largely disengaged with the paintbrush, but a thumb is slightly in contact with the paintbrush. Within this disclosure such contact with the paintbrush will be referred to as being with a “nub” 804 of the thumb, an interior portion of the thumb that is movable and responsive, yet can be activated and moved without needing any “gripping” force. In such a case, again, the “gripping” of the paintbrush or other hand tool is achieved not by the hand itself, but instead by the system 100.

The system 100 allows users to not be required to grasp the paintbrush or other hand tool (e.g. FIG. 12) with thumb, yet the user can still retain manual control of the paintbrush. A user can leave go of the paintbrush and the paintbrush doesn't end up on the ground. A user's fingers (opposed to the thumb) are typically located on the ferrule of the paintbrush. In conventional painting, the fingers not being on the ferrule would likely result in the user dropping the paintbrush entirely. This is a bad loss of time when on a ladder, but is also unwanted even without being on a ladder. Meanwhile, while using the embodiments herein, a user's fingers need not always be in contact with the ferrule, as shown at least within FIGS. 6, 7, and 8.

The system 100 varies in how much support it provides, partly based on how a user positions their own palm and thus indicating how much support is needed. In some cases, the system 100 provides only a slight lessening of the typical paintbrush-grip that would otherwise result in the paintbrush dropping from one's hand. Remember, only a slight lessening of force is sufficient to greatly reduce the amount of injury and harm to a user's hand. This is because such a frequent albeit slight release of a force necessary to achieve a full-grip-force, when multiplied throughout an entire work-day and work-week, results in a marked increase in daily comfort and also reduction of daily hand-grip stress forces. This is also accurate for all tools (see e.g. FIG. 12), and is not limited to paintbrushes.

As illustrated by contrasting FIGS. 6, 7, and 8, the system 100 sometimes produces a substantial lessening of gripping force necessary to hold the paintbrush (e.g. FIGS. 6 and 7). Meanwhile, as shown in FIG. 8, there are other instances where the system 100 produces a slight lessening of gripping force necessary. The reason for this is that the user, in FIG. 8, only needs a slight lessening, as the amount of force needed to operate the paintbrush continually changes every second, depending on what specific type of paintbrush-motion the user is about to undertake.

Next, not all movements of a paintbrush involve applying paint to a surface. For example, in any painting task, there has to also be a “return” motion, where someone may both upstroke and downstroke a surface, or may only apply paint during an downstroke but the upstroke stays free of the surface. These are two completely different motions with two completely different grip-styles needed.

Additionally, a typical painting process will also involve a “dipping” motion, dipping the paintbrush into the paint source, be it a paint-can or paint-tray or something else. Again, this is another completely different repetitive motion, which normally requires changing a grip on the paintbrush.

FIG. 9 shows some detail about installation of the embodiments. Specifically, FIG. 9 shows an example instruction-layout for proper usage, i.e. a “how-to-use” diagram laid out in steps 1, 2L/2R, and 3. FIG. 9 shows how to install the system 100 in a specific way, depending on how that user will employ the system 100. For example, FIG. 9 explicitly suggests locating the protrusion 108 a certain depending on whether to be used by left-handed (2L) or right-handed (2R) user, etc. The protrusion 108 assists in providing a necessary and correct orientation of a user's hand and fingers upon the ferrule of the paintbrush. The directional orientation of the protrusion 108 provides for left-hand or right-hand usage, and thus accommodates even ambidextrous users. That is, the protrusion 108 facilitates consistent and persistent adjustment of the paintbrush orientation in the user's hand thus maintaining a imperturbable orientation of the hand and fingers upon the ferrule of the brush, regardless of the size nor type of brush or other hand-tool.

Within the portion of FIG. 9 labeled “step 2” (bifurcated), there is a top portion “step 2L” (showing attaching the system 100 for a left-handed user), and a bottom portion “step 2R” (showing attaching the system 100 for a right-handed user). FIG. 9 shows how to put on the system 100 and how to not put it on, as demonstrated by the denial-circle 904 (“don't do it this way”). Thus, no matter what, users should roll on the system 100, and not try to slide on the system 100. Attempts to slide on the system 100 will result in very noticeable resistance by the system 100. In that sense, the system 100 “trains” the user in the proper installation technique.

FIG. 10 shows an example, non-limiting method of manufacture for the system 100. As shown in FIG. 10, one of the steps is arranging for an appropriate thermoplastic for the raw material. In an embodiment, the system 100 can be manufactured from EPDM. The thermoplastic can be constructed out of e.g. 64 durometer rating, although base-compositions with other durometer ratings can also be implemented. The specific selection of EPDM is just one of many elastomers that would be suitable. In an embodiment, another elastomer could be any of cis-polyisoprene (natural rubber, NR), cis-polybutadiene (butadiene rubber, BR), styrene-butadiene rubber (SBR), and\or ethylene-propylene monomer (EPM). Further, depending on manufacturing costs, there may be instances where at least the NR embodiment would be vulcanized. However, depending on packaging considerations, wear, shelf-life, and other factors of usage e.g. humidity, what type of climate the system 100 will be sold, temperature, other conditions, either a vulcanized step or non-vulcanized may be appropriate.

Next, in an embodiment, the system 100 can be manufactured in a flat mold, for example a one-sided mold. This is like a waffle being processed in a waffle maker. The mold is on the bottom, on the top is the raw material being molded, e.g. EPDM or other elastomer. The liquid material is poured into the mold, cooked, and then is blown out. The process is repeated, e.g. fill in the mold again, open the mold, and then blow the molded shape out again. It is occasionally necessary to interrupt the process to clean debris and resident from the mold-body.

In manufacturing the embodiments herein, it is possible to use the above, but also possible to use any of injection molding, water-jet cutting, and various forms of 3-D ‘quick printing’ which can be especially helpful in prototyping, and is also usable as a way of mass-producing finished products.

Regarding the specific shape for the system 100, the dual-ring structure for the system 100 as shown in e.g. FIGS. 1-2 should not be considered the only suitable structure. For the handle-facing portion 104h, it is likely best that the interior shape be round or elliptical, in order to best be rolled onto a handle, and also to best facilitate the economy and value of the protrusion 108. However, brush-handles exists which are not cylindrical or round in cross-section.

Next, embodiments exist, depending on the molding style, where the outer surfaces of the handle-facing portion 104h are perhaps slightly more rectangular than perfectly circular, and/or slightly more oblong. One reason for this might be more convenient stacking and inventory management prior to the bubble-pack packaging step. Another reason might be that certain shapes pop out or blow out of the mold more effectively.

In an embodiment, a polished mold can be used, thus precluding any mold marks on the finished system 100. A polished mold can also reduce a requirement for grinding or post-processing. This is sometimes referred to as being “dressed”. Such dressed endings means that either there were never any mold marks in the first place, or the mold marks were deburred so as to remove any extraneous material, either a mold mark or “flash” from the manufacturing process. This also saves on cost of raw material elastomer that is poured into the mold in the first place.

FIG. 11 shows another view of the protrusion 108, rising up on the handle of a paintbrush and thus prominently visible. FIG. 12 shows the system 100 installed on a hand tool being held by a user, where that user's thumb is obscured. The specific type of hand tool shown in FIG. 12 is a cutting instrument, potentially for cutting PVC materials.

### ADDITIONAL ADVANTAGES

The embodiments herein can in some cases permit use of a smaller, thus lighter paintbrush (even when fully paint-laden), without the traditional firm forefinger-auxiliary-fingers-to-thumb gripping/clamping that is typically necessary to hold a paintbrush.

Another work-related and motion-related issue is something as simple as scratching a facial itch/mopping one's brow with hand or kerchief, etc. These tasks are things that painters or other hand tool operators do frequently, especially exterior painters. The embodiments herein permit far greater usage of hands for various important human-needs purposes than painting within a conventional context.

In a professional situation such as on exterior jobs e.g. two or three stories up on scaffolding, ladders, and/or even higher, having the paintbrush affixed to one's hand prevents dropping of the paintbrush. This in turn prevents the 15 minutes or half-hour time-losses due to retrieving and cleaning a dropped paintbrush. Further, the system 100 facilitates safer climbing of scaffolding (both interior and exterior) as painters are frequently hampered in their gripping ability while climbing and moving, at least because of the necessity to hold/control their paintbrush in hand while climbing. This might cause the user to have a weak grip in their paintbrush-holding hand, which could be a safety hazard. Instead, using the system 100, a user can advance up rungs of a ladder or scaffolding employing 4 and maybe all 5 fingers on their tool-bearing hand. Without the system 100, such a user could maybe use 3 of their fingers, and maybe less.

Meanwhile, the various embodiments of the system 100 described herein facilitate a user manipulating a paintbrush outside of the classic ‘paintbrush holding position’, with a greater degree of gripping power and safety. As such, that user is then able to more safely and firmly grasp the various scaffolding or ladder elements. Accordingly, the embodiments herein could some day be incorporated into OSHA requirements for certain job parameters, and potentially recommended by insurers and workman's comp types of agencies. This is because of the injury reduction achieved by the embodiments herein, as well as the reduction in insurance claims.

As stated, the system 100 works just fine whether the user is painting either left-handed or right-handed. Any user can adapt to their specific gripping/motion style, depending only on how that user orients the protrusion 108, or orients the paintbrush within the handle-facing portion 104h.

Using the system 100, a user can let go of the paintbrush and touch something, a sandwich or mobile phone. A user can pause their paintbrush as shown in FIGS. 6-7, or even FIG. 8 and stop and answer a telephone, or dial, or do text-entry on the mobile device, and other similar activities. All without setting down the paintbrush, and all with being able to quickly resume the painting motion. Thus, the advantages of the embodiments disclosed herein go beyond pain relief and extend to ease of use, increased efficiency, and ability to manage interruptions. Further, the system 100 permits a user to more easily eat, drink, and manage other important human-needs tasks which would normally be impossible while holding a paintbrush. This in turn enables that user to still be productive and complete a painting task in considerably less time.

Additionally, the system 100 can work with specialty tools such as mechanic's wrenches, nuclear middle silo repair tools, outer-space-based tools, and anything that demands positive control and retention. One example is shown in FIG. 12, which depicts the system 100 employed with a type of PVC-cutting tool. The system 100 can be modified for artist paintbrush usage and, of course a modification for ADA usage to help retain and control self-feeding apparatus such as fork/spork/spoon may be an iteration.

What is claimed is:

1. A method for facilitating a painting operation involving repetitive motion, comprising:
configuring a system to have a dual ring structure where one ring is a handle-facing ring and the other ring is a finger-facing ring;
configuring the system for allowing a user electing to have their fingers be fully-engaging with a paintbrush not a writing implement; and
configuring the system for allowing a user electing to have their fingers be relaxing and disengaging with the paintbrush while still retaining grip, control, and hand-accessibility of the paintbrush;
wherein the operations of fully-engaging or disengaging are controlled entirely by the user.

2. The method of claim 1, further comprising:
positioning a protrusion within the handle-facing ring.

3. The method of claim 1, further comprising:
configuring the system for having predetermined sizes, widths, and thicknesses suitable for paintbrushes but never for writing implements.

4. The method of claim 1, further comprising:
configuring the system for providing relief of finger-strain, knuckle-strain, joint-strain, and ligament-strain during a painting operation involving repetitive motion.

5. The method of claim 1, further comprising:
facilitating a user's thumb lifting off a surface of the ferrule yet the paintbrush remaining under full control of the user, including an angle and a position of the paintbrush;
facilitating the user's thumb being non-clamped such that a reduction of strain on the user's brush-hand occurs.

6. The method of claim 1, further comprising:
configuring the system such that when one or more fingers are disengaged from the paintbrush, a nub of a user's thumb remaining slightly in contact with the paintbrush; thereby saving strain on bones, ligaments, tendons, and muscles of the user's brush-hand.

7. The method of claim 6, further comprising:
at the user's election, the system gripping and securing the paintbrush while the user's fingers are not gripping the paintbrush.

8. The method of claim 1, further comprising:
the system varying in how much support for the paintbrush is provided by the system, based on how a user is positioning their own palm and fingers and thus indicating how much additional support is needed.

9. The method of claim 8, further comprising:
the system achieving a substantial lessening of a gripping force by a user's hand necessary to hold the paintbrush.

10. The method of claim 8, further comprising:
the system achieving a slight lessening of a gripping force by a user's hand necessary to hold the paintbrush.

11. The method of claim 8, further comprising:
the system arranging that no gripping force whatsoever is needed from a user's hand to still hold the paintbrush.

12. The method of claim 2, further comprising:
the protrusion facilitating an installation of the system by sliding not rolling the system onto a handle of the paintbrush, and
discouraging and preventing installation of the system using any rolling action.

13. The method of claim 12, further comprising:
facilitating the system such that any user-attempts to roll the system onto the handle of the paintbrush are resulting in noticeable resistance by the system such that system trains the user in the proper installation technique.

14. The method of claim 13, further comprising:
the protrusion facilitating a user installing the system to be suitable for right hand use or left hand use, according to a selection of the user.

15. The method of claim 14, further comprising:
configuring the system for adapting to a user's specific gripping/motion style, depending only on how that user orients the protrusion.

16. The method of claim 1, further comprising:
configuring the system for facilitating a user climbing a ladder such the hand bearing the paintbrush can grip the rungs of the ladder using all four fingers of the paintbrush-bearing hand plus the thumb.

17. The method of claim 1, further comprising:
configuring a handle-facing portion with an interior shape that is round or elliptical.

18. The method of claim 17, further comprising:
configuring a plurality of outer surfaces of the handle-facing portion to be rectangular and not circular.

19. The method of claim 15, further comprising:
the protrusion facilitating a consistent and persistent adjustment of the paintbrush orientation in the user's hand.

20. The method of claim 15, further comprising:
the protrusion maintaining an imperturbable orientation of the hand and fingers upon the ferrule of the paintbrush regardless of the size or type of brush.
